(19) United States
(12) Patent Application Publication
(10) Pub. No.: US 2014/0110193 A1
(43) Pub. Date: Apr. 24, 2014

(54) FOLDING STEP ASSEMBLY

(71) Applicant: DEERE & COMPANY, Moline, IL (US)

(72) Inventors: JONATHAN H. CONLEY, Waterloo, IA (US); Trent E. Wiles, Hudson, IA (US); Randy C. Rush, Cedar Falls, IA (US); Brett L. Ehlers, North Liberty, IA (US)

(73) Assignee: Deere & Company, Moline, IL (US)

(21) Appl. No.: 13/659,409

(22) Filed: Oct. 24, 2012

(51) Int. Cl. B60R 3/02; E06C 9/06

(52) U.S. Cl. 182/91

(57) ABSTRACT

A folding step assembly includes a base for attaching to a structure. The base includes a main plate and left and right end plates which project from left and right edges, respectively, of the main plate. A rigid step has an inner end and an outer end, the inner end being pivotally coupled to the base. The step is pivotal from a generally horizontally oriented deployed position to a vertically oriented retracted position. A retained includes a pair of resilient clamp members. Each clamp member engages the step and is deflected towards a corresponding one of the end plates as the step is moved into the retracted position. Each end plate engages the corresponding clamp member to limit deflection of the clamp member.

### FIELD

The present disclosure relates to a folding step assembly.

### BACKGROUND

Certain production tractors have folding steps which can be used to get into and out the tractor cab. This known folding step assembly is complicated to work. It requires two motions to fold down—an upward pull and then a fold-out, while mine is a single fold out motion. This design may also require a large force to loosen the step so that the step can be unfolded or retracted. It desired to have a folding step design which is simple, compact, light in weight, easier to operate and less expensive, and which can be retained in a folded position.

EP1571042 shows a folding step assembly wherein a treadboard or step is hinge-mounted around pins to a support. The step is releasably held in an upward folded storage position by flexible clamp members. However, the clamp members are exposed and unprotected.

### SUMMARY

According to an aspect of the present disclosure, a folding step assembly includes a base for attaching to a structure, a rigid step and a retainer member. The step is pivotally coupled to a lower end of the base. The base includes a main plate and left and right end plates which project from left and right edges of the main plate. The step is pivotal from a generally horizontally deployed position to a vertically orients retracted position. The retainer member includes a pair of resilient clamp members. Each clamp member engages the step and is deflected towards a corresponding one of the end plates as the step is moved into the retracted position. Each end plate engages the corresponding clamp member to limit deflection of the clamp member. The end plates cover and protect the clamp members and help prevent them from being damaged.

### BRIEF DESCRIPTION OF THE DRAWINGS

FIG. 1 is perspective view of a folding step assembly embodying the invention in a deployed state; and

FIG. 2 is a perspective view of the folding step assembly of FIG. 1 in a retracted state;

FIG. 3 is a sectional view of the folding step along lines 3-3 of FIG. 1; and

FIG. 4 is top view of the folding step assembly of FIG. 1 showing the deflection of the spring clip;

FIG. 5 is top view of the folding step assembly of FIG. 1 in the fully retracted state.

### DETAILED DESCRIPTION OF THE DRAWINGS

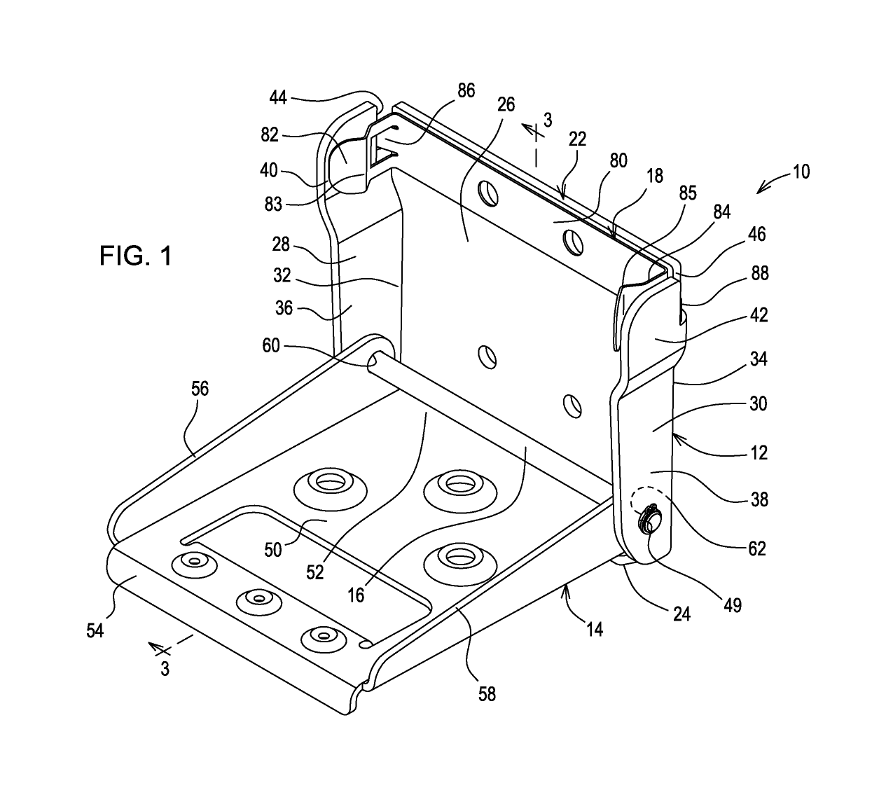

Referring to FIGS. 1, 2 and 3, a folding step assembly 10 includes a rigid base or mounting plate 12, a rigid step 14, a pivot pin 16 and a retainer clip 18. The base 12 is adapted to be mounted to a structure, such as a vehicle (not shown) and includes a plurality of mounting holes 20 for this purpose. The base 12 has an upper end 22 and a lower end 24. The base 12 includes a main base plate 26 and left and right end plates 28 and 30 which project from left and right edges 32 and 34, respectively, of the main base plate 26. Each end plate 28, 30 includes a lower portion 36, 38 and an upper portion 40, 42. The upper portions 40, 42 are separated by a first distance, and the lower portions 36, 38 are separated by a second distance. The first distance is larger than the second distance. A pair of slots 44, 46 extend into upper corners of the base. Each slot is formed between the main plate 26 and a respective one of the end plate upper portions 40, 42, respectively. Bores 47 and 49 are formed in the lower ends of the lower portions 36 and 38.

The step 14 has main plate 50 having an inner end or edge 52 and an outer end 54, and left and right side members 56 and 58 which project at about right angles form the edges of the main plate 50. The side members 56 and 58 are preferably tapered from their inner ends to their outer ends. The inner ends of the side members 56 and 58 have pivot bores 60 and 62 formed therein.

A pivot pin 70 is received by bores 47 and 49 in the lower ends of the lower portions 36 and 38, and is thereby supported by the lower end of the base 12. The pivot pin 70 is also received by bores 60 and 62 in the side members 56 and 58, and the step 14 is pivotally coupled to the base 12.

The retainer member 18 includes an elongated plate 80 and left and right resilient spring arms or clamp members 82 and 84 which project from opposite ends of the plate 80. Clamp members 82 and 84 form includes ridges 83 and 85, respectively, which project towards each other. A pair of tabs 86 and 88 project away from each other and from opposite ends of the plate 80. Each tab 86 and 88 is received by a corresponding one of slots 44 and 46. Each clamp member 82, 84 forms a recess 90, 92, respectively, between the ridge 83, 85 and the corresponding end of the plate 80. The retaining force produced by the retainer member 18 can be changed by varying the thickness and width of the clamp members 82 and 84. The retainer member 18 is held by a combination of mounting bolts (not shown) and the tabs 86 and 88 which are received by the slots 44 and 46.

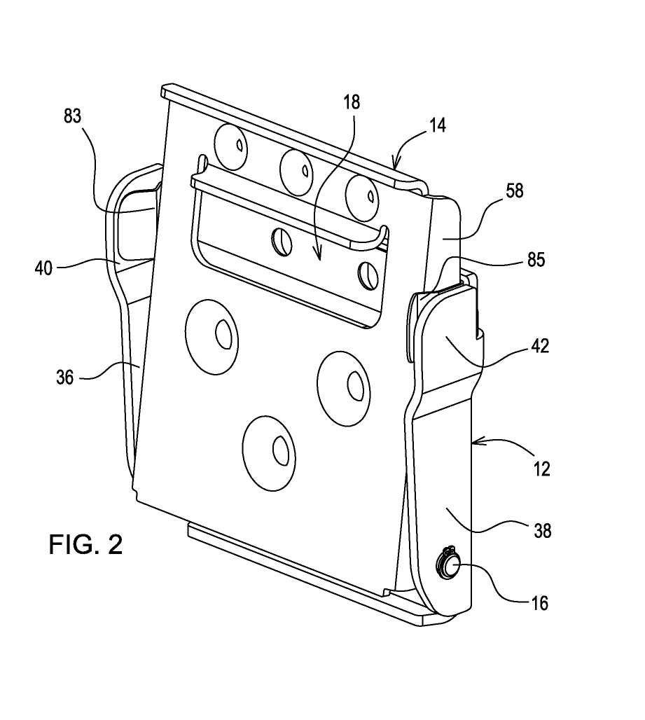

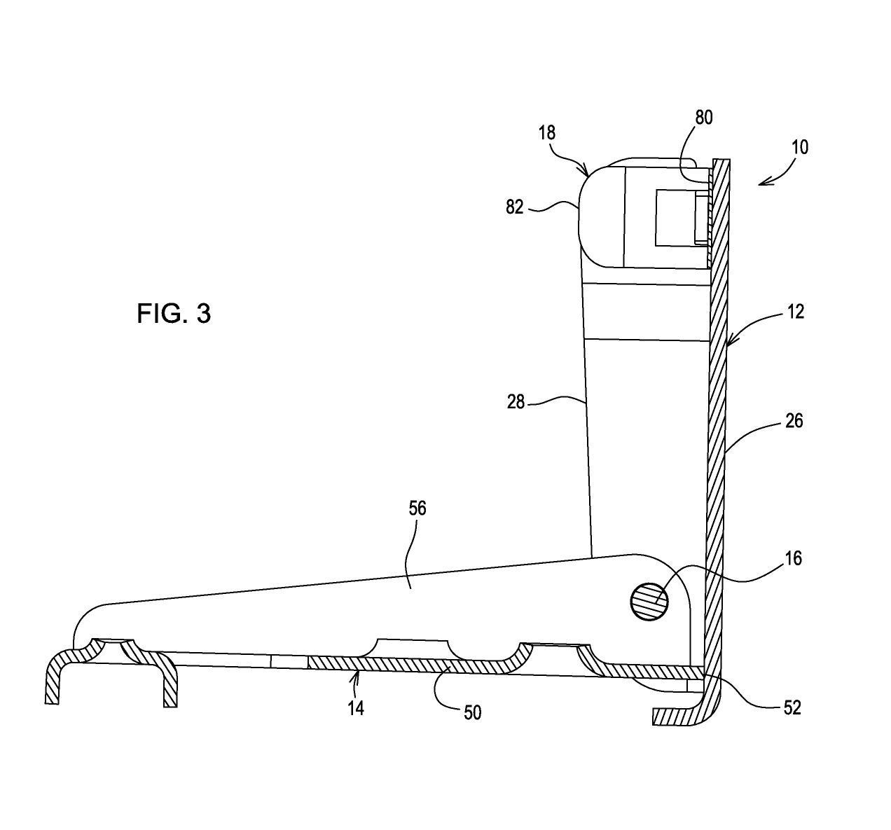

As best seen in FIG. 3, when the step 14 is unfolded into its deployed position, the edge or end 52 of main step plate 50 engages the surface of main base plate 26, and this engagement holds the step 14 in a generally horizontal position. From this deployed position, the step 14 can be easily pivoted upwardly around the axis of pin 70 and up into its folded or retracted position best seen in FIG. 2. During this motion, the step 14 engages and deflects the clamp members 82 and 84 outwardly and away from each other and towards a corresponding one of the upper portions 40, 42 as the step 14 is moved into the retracted position. Then, the step 14 moves into the recesses 90 and 92 and the clamp members 82 and 84 are engagable with the step 14 to releasably hold the step 14 in its retracted position. In its retracted position, the outer end 54 of the step 14 is adjacent the plate 80 and the upper end 22 of the base 12, and the step 14 is generally vertically oriented.

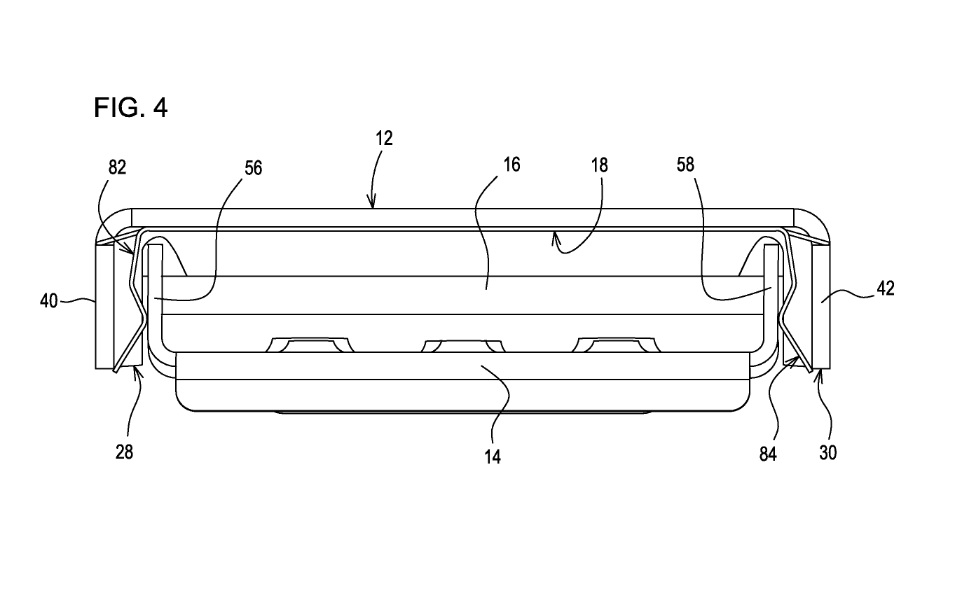

As best seen in FIG. 4, each clamp member 82 and 84 engages the step 14 and is deflected into engagement with a corresponding one of the end plates 28, 30 as the step 14 is moved towards the retracted position. Each end plate portion 40, 42 engages the corresponding clamp member 82, 84 to limit deflection of the clamp member 82, 84.

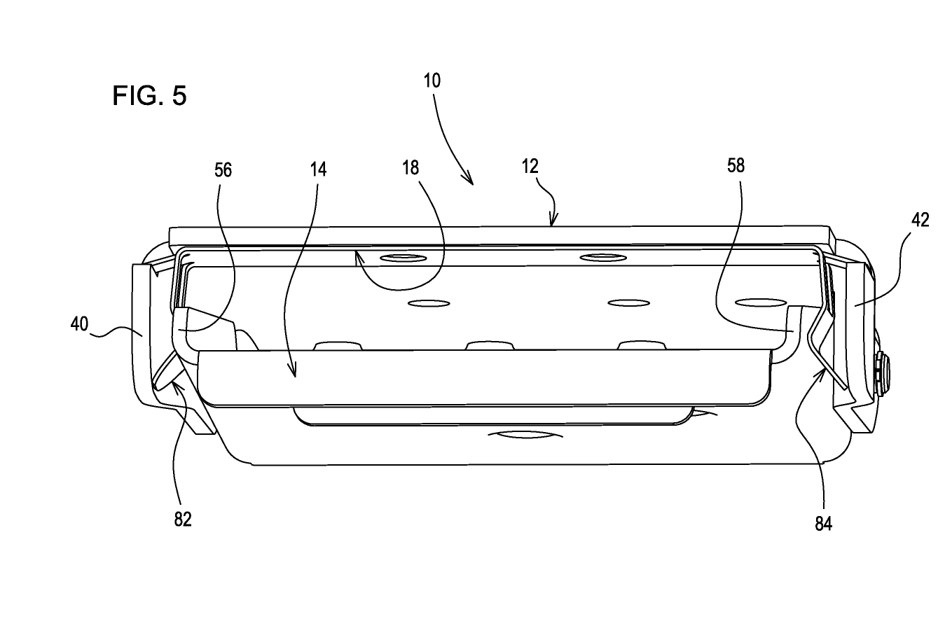

As best seen in FIG. 5, when the step 14 is in the fully retracted state, each clamp member 82 and 84 rebounds away from the corresponding end plate portion 40, 42 and hold the step 14 in the fully retracted position.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

We claim:

1. A folding step assembly, comprising:
a base for attaching to a structure, the base comprises a main plate and left and right end plates which project from left and right edges, respectively, of the main plate;
a rigid step pivotally coupled to the base, the step having an inner end and an outer end, the step being pivotal from a generally horizontally projecting deployed position to a retracted position wherein the outer end of the step is adjacent to a portion of the base; and
a pair of resilient clamp members, each clamp member engaging the step and being deflected towards a corresponding one of the end plates as the step is moved into the retracted position, each end plate engaging the corresponding clamp member to limit deflection of the clamp member.

2. The folding step assembly of claim 1, further comprising:
a pivot pin supported by a lower end of the base, the step having a pivot bore which receives the pivot pin.

3. The folding step assembly of claim 1, wherein:
the clamp members project from opposite ends of a retainer plate, the retainer plate being mounted to the main plate of the base.

4. The folding step assembly of claim 1, wherein:
a pair of slots extend into the base, each slot being formed between the main plate and a respective one of the end plates.

5. The folding step assembly of claim 4, wherein:
a retainer plate is mounted to the main plate of the base; and
a pair of tabs project from opposite ends of the retainer plate, each tab being received in a corresponding one of the slots.

6. The folding step assembly of claim 1, wherein:
each end plate having a lower portion and an upper portion, the upper portions being separated by a first distance, the lower portions being separated by a second distance, the first distance being larger than the second distance.

7. The folding step assembly of claim 6, wherein:
each upper portion engaging a corresponding clamp member to limit deflection of the clamp member.

8. The folding step assembly of claim 1, wherein:
a pair of slots extend into the base;
a retainer plate is mounted to the main plate of the base; and
a pair of tabs project from opposite ends of the retainer plate, each tab being received in a corresponding one of the slots.

9. A folding step assembly, comprising:
a step which is pivotal from a generally horizontally oriented deployed position to a generally vertically oriented retracted position;
a pair of fixed end plates; and
a pair of resilient clamp members, each clamp member engaging the step and being deflected towards a corresponding one of the end plates as the step is moved into the retracted position, each end plate engaging the corresponding clamp member to limit deflection of the clamp member.

10. The folding step assembly of claim 9, further comprising:
a base for mounting to a structure, the end plates projecting from opposite ends of the base.

11. The folding step assembly of claim 9, further comprising
a fixed retainer plate, the clamp members projecting from opposite ends of the retainer plate.

12. The folding step assembly of claim 11, further comprising:
a base for mounting to a structure, the base having a pair of slots formed therein; and
the retainer member comprises a pair of tabs, each tab being received in a corresponding one of the slots.

13. The folding step assembly of claim 12, wherein:
the end plates project from opposite ends of the base, and each slot is formed between the main plate and one of the end plates.

14. The folding step assembly of claim 9, further comprising:
a base for mounting to a structure; and
a pivot pin supported by a lower end of the base, the step having a pivot bore which receives the pivot pin.
